(19) United States
(12) Patent Application Publication
(10) Pub. No.: US 2019/0228446 A1
(43) Pub. Date: Jul. 25, 2019

(54) PLURAL USER TRANSACTION SYSTEM AND METHODS

(71) Applicant: GIFTWITH INC, Tenafly, NJ (US)

(72) Inventor: Eshed Doni, Tenafly, NJ (US)

(73) Assignee: GIFTWITH INC, Tenafly, NJ (US)

(21) Appl. No.: 16/252,605

(22) Filed: Jan. 19, 2019

Related U.S. Application Data
(60) Provisional application No. 62/709,507, filed on Jan. 22, 2018.

(51) Int. Cl. G06Q 30/06; G06Q 20/12

(52) U.S. Cl. CPC G06Q 30/0605; G06Q 20/12

(57) ABSTRACT

A plural user transaction system and methods are provided which facilitates easy creation of any number of group gifts by one or more gifting users which may be provided to one or more recipient users. In some embodiments, several gifts of the system may be displayed together on a client device of a user, allowing users to select the gifts they would like to join and do so easily without having to provide the same information repeatedly. At the same time the personalization options will be available for the gift participants allowing them to customize every gift they join with their own personal information as well as a personalized greeting. In this manner, the system is configured to enable the buying of any number of group gifts by any number of gifting users for any number of recipient users.

### CROSS REFERENCE TO RELATED APPLICATIONS

This application claims priority to and the benefit of the filing date of U.S. Provisional Application No. 62/709,507, filed on Jan. 22, 2018, entitled “Method and system for buying any number of gifts by any number of gift participants”, which is hereby incorporated by reference in its entirety.

### FIELD OF THE INVENTION

This patent specification relates to the field of systems and methods configured to enable collective item purchasing. More specifically, this patent specification relates to systems and methods configured to enable any number of users to collectively purchase any number of gifts.

### BACKGROUND

For various occasions such as the holidays and before the end of the school year, many parents want to express their appreciation for the staff of their children's schools through buying staff members appreciation gifts.

However, arranging a single group gift from several participants is a cumbersome process that involves sending numerous reminders, collecting cash, carrying change, meeting the other gift participants, etc., let alone, arranging several group gifts in parallel which is a very tedious and time-consuming task.

Therefore, a need exists for novel computer-implemented systems and methods for arranging and buying any number of group gifts, each of them allowing an unlimited number of gift participants, simple, straightforward and hassle free.

### BRIEF SUMMARY OF THE INVENTION

A plural user transaction system and methods are provided which facilitates easy creation of any number of group gifts by one or more gifting event administration users which may be provided to one or more recipient users. In some embodiments, several gifts of the system may be displayed together on a client device of a user, allowing users to select the gifts they would like to join and do so easily without having to provide the same information repeatedly. At the same time the personalization options will be available for the gift participants allowing them to customize every gift they join with their own personal information as well as a personalized greeting. A gifting event administration user may comprise an individual or entity which may desire to enable or provide all or portions of an item, such as a gift, to be given one or more recipient users. A recipient user may comprise an individual or entity which may receive all or portions of an item, such as a gift, from one or more gifting users. In preferred embodiments, the system may enable gifting users to choose or decide how to split a gift among recipient users. In this manner, the system is configured to enable the buying of any number of group gifts by any number of gifting users for any number of recipient users.

According to one embodiment consistent with the principles of the invention, a computer implemented method for creating a multiple user gifting event is provided. In some embodiments, the method may include the steps of: recording, on a server, data describing a gifting event, the data provided via a first client device of a gifting event administration user; generating, on the server, a gifting event unique identifier for the gifting event; recording, on the server, data describing each recipient user for the gifting event, the data provided via the first client device of the gifting event administration user; assigning a gift, on the server, to each recipient user; and generating, on the server, a gift unique identifier for the gift.

According to another embodiment consistent with the principles of the invention, a computer implemented method for completing a multiple user gifting event transaction is provided. In some embodiments, the method may include: receiving a first gift unique identifier from a first user via a first client device; associating a payment data of the first user with the first gift unique identifier on a server, the payment data including a first gift amount; receiving a second gift unique identifier from the first user via the first client device; associating the payment data of the first user with the second gift unique identifier on the server, the payment data including a second gift amount; completing a transaction using the payment data of the first user on the server, the transaction covering both the first gift amount and second gift amount; and associating the first user with the first gift unique identifier and the second gift unique identifier on the server.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a plural user transaction system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating some applications of a plural user transaction system which may function as software rules engines according to various embodiments described herein.

FIG. 5 illustrates a block diagram illustrating an example of a system database according to various embodiments described herein.

FIG. 6 shows a block diagram of an example of a computer-implemented method for creating a multiple user gifting event according to various embodiments described herein.

FIG. 7 depicts a block diagram of an example of a computer-implemented method for completing a multiple user gifting event transaction according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Definitions

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods configured to enable collective item purchasing are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

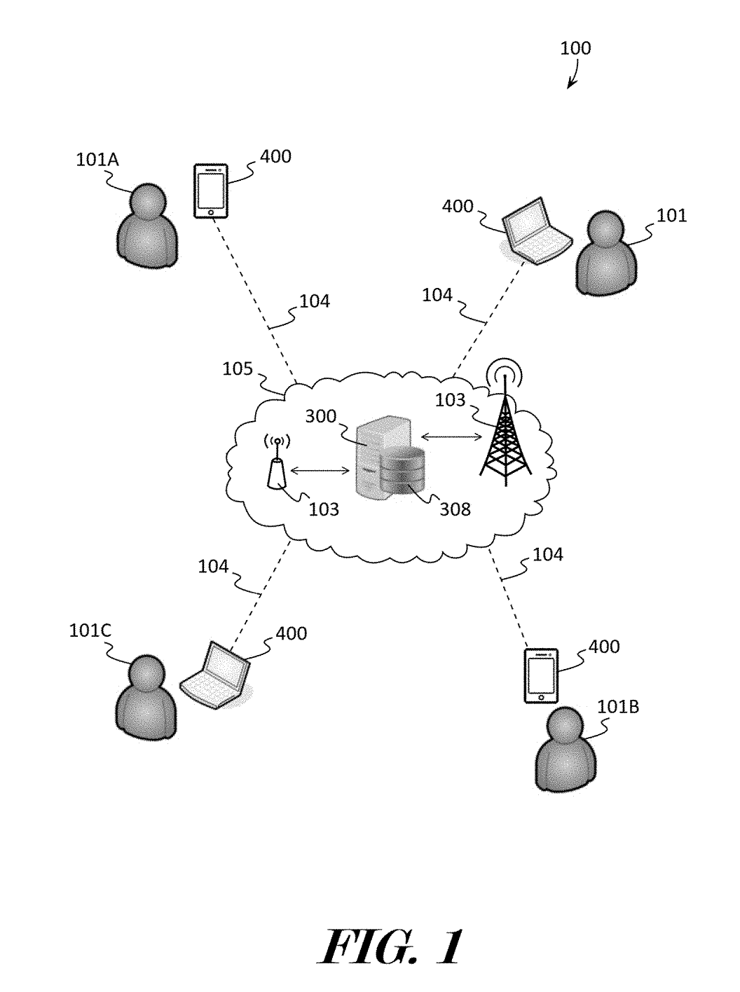

The present invention will now be described by example and through referencing the appended figures representing preferred and alternative embodiments. As perhaps best shown by FIG. 1, an illustrative example of some of the physical components which may comprise a plural user transaction system (“the system”) 100 according to some embodiments is presented. The system 100 is configured to facilitate the transfer of data and information between one or more access points 103, client devices 400, and servers 300 over a data network 105. Each client device 400 may send data to and receive data from the data network 105 through a network connection 104 with an access point 103. A data store 308 accessible by the server 300 may contain one or more databases. The data may comprise any information which may be used for the arranging and buying any number of items, such as group gifts, each of them allowing an unlimited number of gifting users 101A or gifting participants.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

In some embodiments, the system 100 may be configured to facilitate the communication of information to and from one or more users 101, through their respective client devices 400, and servers 300 of the system 100. Users 101 of the system 100 may include one or more gifting users 101A, recipient users 101B, and gifting event administration users 101C. A gifting event administration user 101C may comprise and individual or entity which may desire to enable or provide all or portions of an item, such as a gift, to be given one or more recipient users 101B. A gifting user 101A may comprise an individual that desires to financially or otherwise contribute to a gift 122 for a recipient user 101B. Generally, a gifting event administration user 101C is a user 101 that initiates the creation of gifting events 121 and gifts 122 in the system, while a gifting user 101A joins and contributes to the one or more gifting events 121 and gifts 122. An individual or user 101 may be a gifting event administration user 101C and/or a gifting user 101A. A recipient user 101B may comprise an individual or entity which may receive all or portions of an item, such as a gift, from one or more gifting users 101A. In this manner, the system 100 is configured to enable the buying of any number of group gifts by any number of gifting users 101A for any number of recipient users 101B.

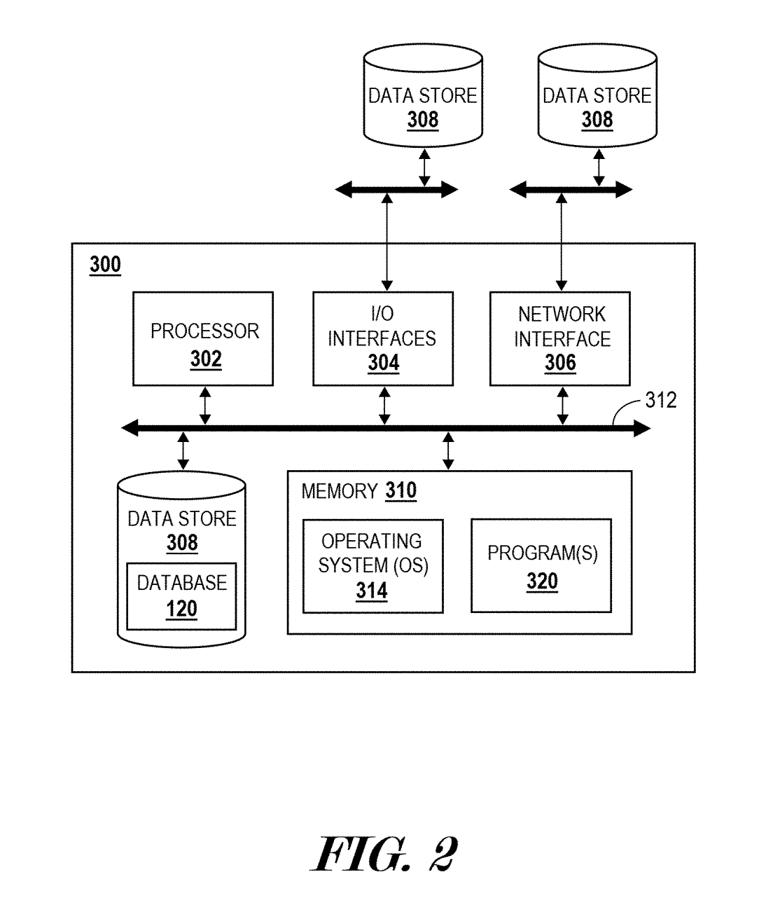

Referring now to FIG. 2, in an exemplary embodiment, a block diagram illustrates a server 300 of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

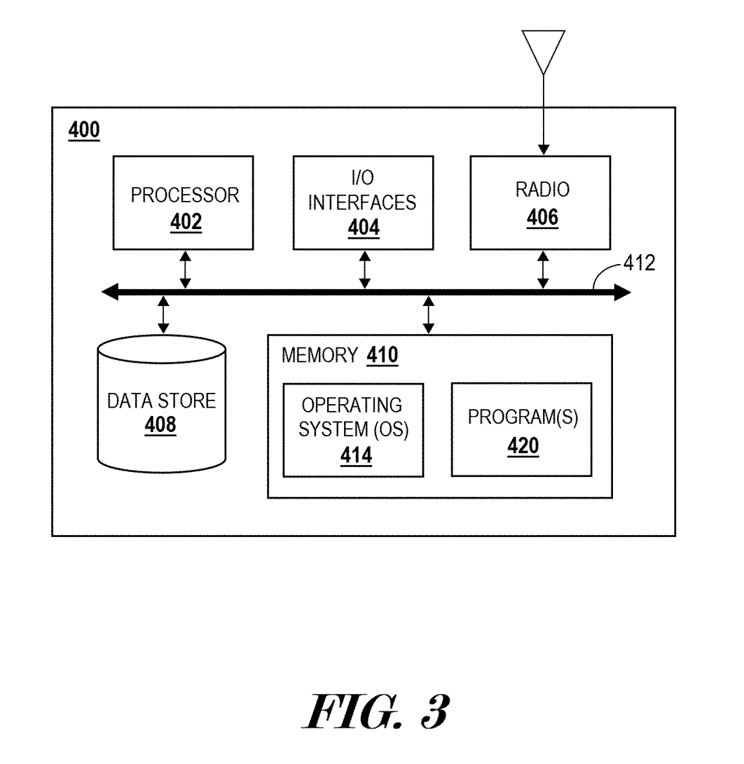

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory.

The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

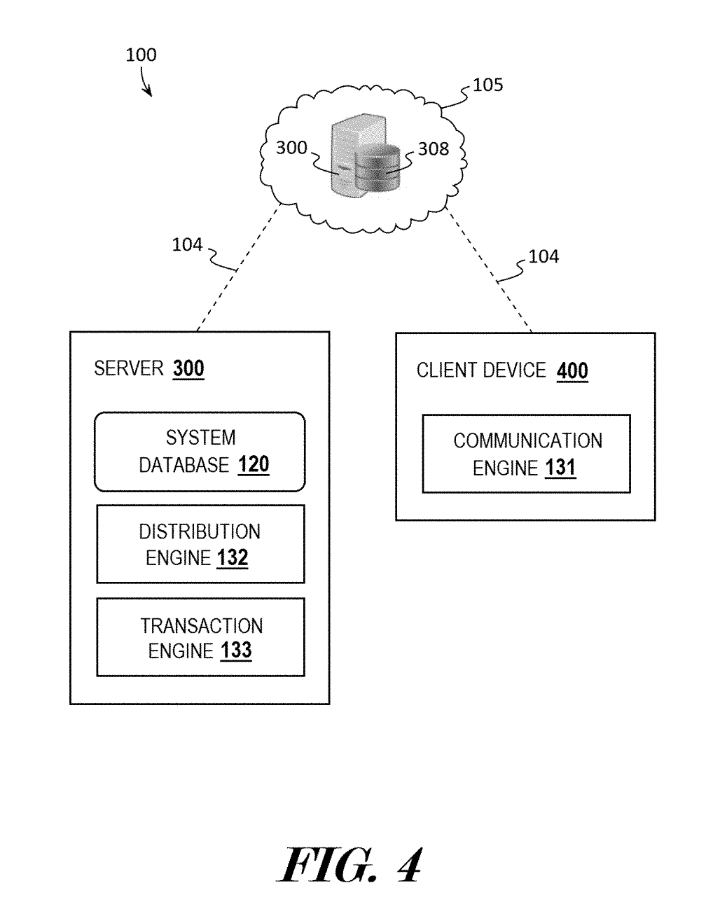

Referring now to FIG. 4 a block diagram showing some software rules engines which may be found in a system 100 (FIG. 1) and which may optionally be configured to run on one or more servers 300 and/or client devices 400 that may be in communication with a system database 120 according to various embodiments described herein are illustrated. A server 300 and client device 400 may be in wired and/or wireless electronic communication through a network 105 with a data store 308 comprising a database, such as a system database 120. The engines 321, 322, 421, may read, write, or otherwise access data in one or more databases 120 of one or more data stores 308. Additionally, the engines 321, 322, 421, may be in electronic communication so that data may be readily exchanged between the engines 321, 322, 421.

In this and some embodiments, one or more servers 300 may be configured to run one or more software rules engines or programs such as a distribution engine 132 and a transaction engine while a client device 400 may be configured to run one or more software rules engines or programs such as a communication engine 131. In other embodiments, a communication engine 131, distribution engine 132, and/or transaction engine 133 may be configured to run on one or more client devices 400 and/or servers 300 with data transferred to and from one or more servers 300 in communication with a data store 308 through a network 105. In still further embodiments, a server 300 or a client device 400 may be configured to run a communication engine 131, distribution engine 132, and/or transaction engine 133. It should be understood that the functions attributed to the engines 131, 132, 133, described herein are exemplary in nature, and that in alternative embodiments, any function attributed to any engine 131, 132, 133, may be performed by one or more other engines 131, 132, 133, or any other suitable processor logic.

The system 100 may comprise one or more databases, such as a system database 120 stored on a data store 308 accessible to the one or more engines 131, 132, 133. In some embodiments, a system database 120 may comprise information that one or more users 101 desire to input into the system 100 including data describing one or more users 101, data describing one or more gifting events, data describing one or more gifts, data describing one or more users 101 associated with one or more gifting events and gifts, data describing payment information, data describing transaction information, data describing one or more greetings associated with one or more users 101, and any other information that a user 101 may input or that the system 100 may output. It should be understood that the described structure of the system database 120 is exemplary in nature, and that in alternative embodiments, the data contained within the system database 120 may be organized in any other way.

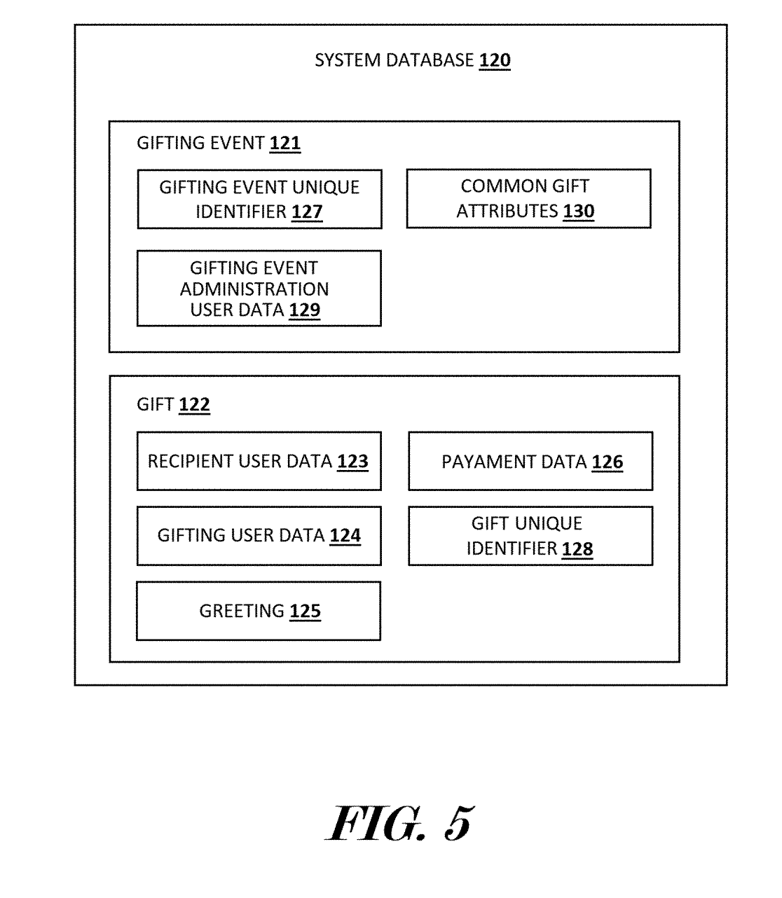

Turning now to FIG. 5, the system database 120 may comprise one or more gifting event 121 data records. Preferably, one or more gift 122 data records may be associated with each gifting event 121. Additionally, the system database 120 may comprise one or more data fields which may be associated with one or more gifting events 121 and/or gifts 122. These data fields may include: recipient user data 123; gifting user data 124; greeting 125; and/or payment data 126.

The gifting event 121 data record may contain information or data input by one or more users 101 which may describe the name, purpose, and/or other descriptive information of a gifting event. This descriptive information may be used to populate each gift 121 data record that the system 100 may generate for each recipient user 101B of a gifting event 121. A gifting event 121 data record may include a common gift attributes 130 record which may contain common data that may be replicated to all the gifts 122 that are associated with the same gifting event 121. Generally, a gifting event may comprise a date, reason, or purpose for giving one or more gifts to one or more recipient users 101B. For example, a gifting event 121 may be the end of the school year in which a gift may be given to each teacher in a grade at a school. In this example, the gifting event 121 data record may contain information such as “End of School Year Gifts For Fourth Grade Teachers”. In preferred embodiments, a gifting event 121 data record may include data describing how a gifting user 101A and/or the gifting event administration user 101C has chosen or decided how to split a gift associated with the gifting event 121 among recipient users 101B.

One or more gifts 122 may be associated with a gifting event 121. Generally, a gift may comprise an item or the like which may be given to a recipient user 101B. A gift 122 data record may contain information or data input by one or more users 101 which may describe a gift, such as the name, cost, date to be delivered, and the like. In preferred embodiments, a gift 122 data record may include or be associated with one or more data records such as recipient user data 123, one or more gifting user data 124 records, one or more greeting 125 records, one or more payment data 126 records, and a gift unique identifier 128. In some embodiments, data records 123-126 can be different for different gifts 122 within the same gifting event 121 or can be shared for several gifts 122 within the same gifting event 121. Continuing the above example, one gift may be given to all five of the fourth grade teachers so that one gift 122 may be associated with the gifting event 121 or one gift may be given to each of the fourth-grade teachers so that five gifts 122 may be associated with the gifting event 121. In preferred embodiments, a gift 122 data record may include data describing how a gifting user 101A and/or the gifting event administration user 101C has chosen or decided how to split a gift among recipient users 101B.

In preferred embodiments, each gift 122 may be associated with a gift unique identifier 128 in the system database 120. In further embodiments, a gift unique identifier 128 may comprises a Uniform Resource Locator (URL) unique to each gift 122. In still further embodiments, a gift unique identifier(s) 128 may comprise an alphanumeric string, digital code, etc., which may be generated by the distribution engine 132 and which may be assigned or associated to that gift 122 in the system database 120.

A recipient user data 123 record may contain information or data input by one or more users 101 which may describe the name, contact information, account, and/or other descriptive information of a recipient user 101B.

A gifting user data 124 record may contain information or data input by one or more users 101 which may describe the name, contact information, account, login credentials, and/or other descriptive information of a gifting user 101A. Optionally, a gifting user data 124 record may contain financial account information of the gifting user 101A, such as credit card information or other third-party payment information which may be used by the system 100 to process payment for one or more gifts 122. In preferred embodiments, when a gifting user 101A use their credentials to connect, payment data 126, greeting 125, and/or other data previously associated with gifts 122 that the gifting user 101A joined previously can be used again by being associated with one or more other gifts 122 selected by the gifting user 101A.

A greeting 125 record may contain information or data input by one or more users 101 which may describe the information which may be presented to a recipient user 101B, preferably via their client device 400, such as when a gift 122 is presented or otherwise conveyed to the recipient user 101B. Preferably, a greeting 125 record may contain information entered by one or more gifting users 101A that contributed to a gift 122 for a recipient user 101B. In preferred embodiments, the greeting 125 provided by a gifting user 101A that has been associated with a gift 122 of a gifting event 121 may be associated with any other gift 122 associated with the gifting event 121 if the gifting user 101A desires to join those gifts 122. In this manner, the gifting user 101A may elect to use the same greeting 125 for two or more gifts 122 of a gifting event 121.

A payment data 126 record may contain information or data input by one or more users 101 or financial entities which may describe how one or more gifting users 101A paid for or completed a transaction for a gift 122 and/or information which may describe how a transaction for a gift occurred. Generally, a payment data 126 record may contain transaction information for how a gift 122 may be or was purchased or otherwise conveyed to one or more recipient users 101B from one or more gifting users 101A. In preferred embodiments, the payment data 126 of a gifting user 101A that has been associated with a gift 122 of a gifting event 121 may be associated with any other gift 122 associated with the gifting event 121 if the gifting user 101A desires to join those gifts 122. In this manner, the gifting user 101A may elect to use the same payment data 126 for two or more gifts 122 of a gifting event 121.

In preferred embodiments, each gifting event 121 data record and/or gift 122 data record may be associated with a gifting event unique identifier(s) 127 in the system database 120. In preferred embodiments, once the gifts 122 of a gifting event 121 are created, a gifting event unique identifier(s) 127 may be generated by the distribution engine 132 which may be assigned or associated to that gifting event 121 in the system database 120. In further embodiments, a gifting event unique identifier 127 may comprise a Uniform Resource Locator (URL) unique to each gifting event 121. In still further embodiments, a gifting event unique identifier(s) 127 as well as unique event ID, such as an alphanumeric string, digital code, etc., may be generated by the distribution engine 132 which may be assigned or associated to that gifting event 121 in the system database 120.

A gifting event administration user data 129 record may contain information or data input by one or more users 101 which may describe the name, contact information, account, and/or other descriptive information of a gifting event administration user 101C. Optionally, a gifting event administration user data 129 record may contain login credentials, information which may be used to define or create a gifting event 121 and the one or more gifts 122 of that gifting event 121, and financial account information of the gifting event administration user 101C, such as credit card information or other third-party payment information which may be used by the system 100 to process payment for one or more gifts 122.

A common gift attributes 130 record may contain information or data input by one or more gifting event administration users 101C. This data may include information which may be common to two or more gifts 122 of a gifting event 121, and which the distribution engine 132 may use to populate one or more fields or data records of the two or more gifts 122 of the gifting event 121. In some embodiments, data of a common gift attributes 130 record may include information which may be used by the distribution engine 132 to populate fields or data records of two or more gifts 122 associated with a gifting event 121, such as gift 122 data records, gifting user data 124 records, greeting 125 records, and payment data 126 records. In this manner, a gifting event administration user 101C may enter information that is common to two or more gifts 122 of a gifting event 121, and the distribution engine 132 may automatically populate the data records 123-126 of the gifts 122 with the common information so that the gifting event administration user 101C does not have to re-enter the information for each gift 122.

Referring also for FIG. 4, in some embodiments, a communication application 131 may comprise or function as input logic stored in the memory 310, 410 which may be executable by the processor 302, 402, of a server 300 and/or client device 400. The communication application 131 may receive input from the user 101, preferably through an I/O interface 304,404, and the input may comprise information for populating a gifting event 121, gift 122, recipient user data 123, gifting user data 124, greeting 125, payment data 126, and/or any other data record of a system database 120. The communication application 131 may also read, write, edit, create, import, export, and delete information system database 120.

A communication application 131 may comprise or function as display logic stored in the memory 310, 410 which may be executable by the processor 302, 402, of a server 300 and/or client device 400. In some embodiments, the communication application 131 may display to the user 101, via a display screen 404A of the client device 400, information which may be output by the system 100 such as information from the system database 120.

A distribution engine 132 may comprise or function as distribution logic stored in the memory 310, 410 which may be executable by the processor 302, 402, of a server 300 and/or client device 400. In some embodiments, a distribution engine 132 may be configured to create, edit, or otherwise modify one or more gift 122 data records and gifting event 121 data records in the system database 120. In further embodiments, a distribution engine 132 may be configured to create, edit, or otherwise modify one or more recipient user data 123 records in the system database 120. In still further embodiments, a distribution engine 132 may be configured to create, edit, or otherwise modify one or more gifting user data 124 records in the system database 120. In yet further embodiments, a distribution engine 132 may be configured to generate a gift 122 for each recipient user 101B of the recipient user data 123 records of a gift 122 or a gifting event 121 recipient list and the gifting event details into a collection of gifts, In further embodiments, a distribution engine 132 may be configured to generate a gifting event unique identifier(s) 127 and/or a unique event ID, such as an alphanumeric string, digital code, etc., which may be assigned or associated to each gifting event 121 and/or gift 122 in the system database 120.

A transaction engine 133 may comprise or function as transaction logic stored in the memory 310, 410 which may be executable by the processor 302, 402, of a server 300 and/or client device 400. In some embodiments, a transaction engine 133 may be configured to process transactions or payments by a gifting user 101A which may be used to buy gifts 122 for recipient users 101B. In further embodiments, a transaction engine 133 may be configured to create, edit, or otherwise modify payment data 126 records in the system database 120.

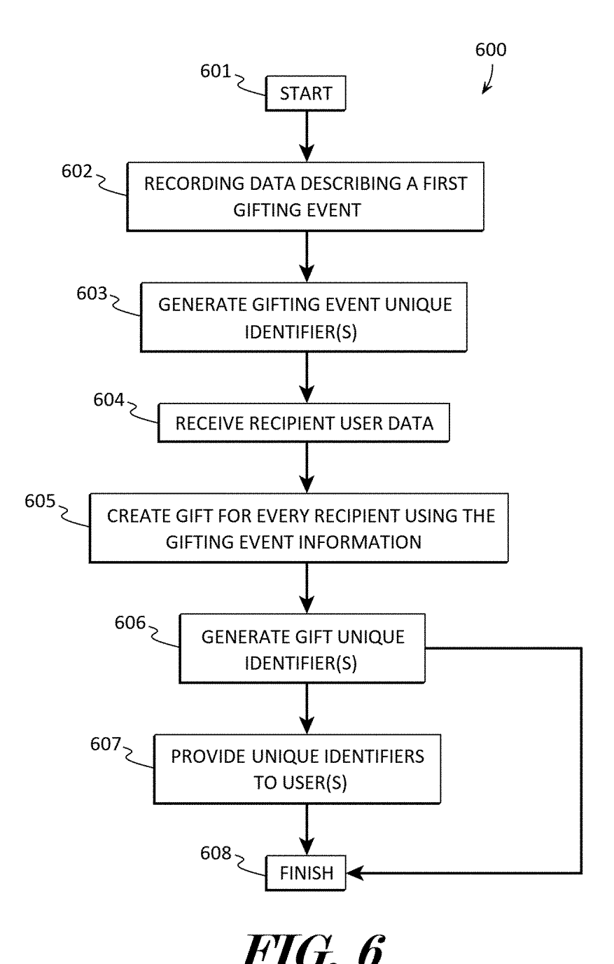

FIG. 6 shows a block diagram of an example of a computer-implemented method for creating a multiple user gifting event (“the method”) 600 according to various embodiments described herein. In some embodiments, the method 600 may be used to create a gifting event 121 in the system database 120 which may be associated with one or more gifts 122 for one or more recipient users 101B. One or more steps of the method 600 may be performed by a communication engine 131, distribution engine 132, and/or transaction engine 133 which may be executed by a computing device processor, such as a processor 302 (FIG. 2) and/or a processor 402 (FIG. 3).

In some embodiments, the method 600 may start 601 and data describing a gifting event 121 may be recorded in step 602. In preferred embodiments, data describing a gifting event 121 may be provided via a first client device 400 of a first user, such as a gifting event administration user 101C, and the data may be recorded on a server 300, such as in a system database 120. The gifting event administration user 101C may provide the input to the communication engine 131 running on their client device 400. Optionally, the gifting event administration user 101C may comprise an event administrator or other individual. In further embodiments, the system 100 may receive a user credential, such as a login name and password, from the gifting event administration user 101C via their client device 400 which may be associated with the gifting event 121 in the system database 120.

In step 603, a gifting event unique identifier(s) 127 may be generated by the distribution engine 132. In preferred embodiments, once the data describing the gifting event 121, a gifting event unique identifier(s) 127 for that gifting event 121 may be generated by the distribution engine 132 which may be assigned or associated to that gifting event 121 in the system database 120. In further embodiments, one or more gifting event unique identifiers 127 may comprises a Uniform Resource Locator (URL) unique to each gifting event 121. In still further embodiments, a gifting event unique identifier(s) 127 as well as unique event ID, such as an alphanumeric string, digital code, etc., may be generated by the distribution engine 132 which may be assigned or associated to that gifting event 121 in the system database 120.

In step 604, the system 100 may receive data for or describing one or more recipient users 101B. In preferred embodiments, data describing each recipient user 101B for the gifting event 121 may be provided via a client device 400 of the gifting event administration user 101C and may be recorded as recipient user data 123 on a server 300, such as in a system database 120. The gifting event administration user 101C may provide the input (data for or describing one or more recipient users 101B) to the communication engine 131 running on their client device 400. In further embodiments, the recipient user data 123 (data describing each recipient user 101B) may be associated with the user credentials received in step 602 on the server 300 in the system database 120.

As gifting events 121 are comprised of a list of recipient users 101B and gifting event details that contain common gift 122 attributes (stored in a common gift attributes 130 record of the gifting event 121 data record), the system 100 may be configured to check whether a recipient user 101B list already exists in the system database 120. In some embodiments, the data describing one or more recipient users 101B may be received from a user 101 via a communication engine 131 of their client device 400. In this manner, the system 100 may provide the user 101 with the ability to upload an existing list of data describing one or more recipient users 101B. In further embodiments, the data describing one or more recipient users 101B may be retrieved from a server 300, such as from a system database 120. In this manner, the system 100 may provide the user 101 with the ability to select a file that contains a list of data describing one or more recipient users 101B and for every recipient user data 123 record in that file, a recipient users 101B may be added to the system database 120 and preferably associated with the gifting event 121 and/or the credentials of the first user or gifting user 101A. In still further embodiments, alternatively, the first user or gifting user 101A can choose to import the list from an external system or server 300. In that case a connection may be established to the external system, the list will be retrieved, and for every recipient user 101B record in that file, a recipient user data 123 record will be added to the recipients list of the gifting event 121.

In step 605, a gift 122 may be created for every recipient user 101B using the gifting event information entered in step 602 by the distribution engine 132. In preferred embodiments, a gift 122 may be created for every recipient user 101B by assigning a gift 122 to each recipient user data 123 record on the server 300, such as in the system database 120. Generally, the distribution engine 132 may convert the recipient user list of step 603 and the gifting event details of the gifting event data record 121 into a collection of gifts 122, preferably one gift 122 per every recipient user data record 123 from the recipients list. The common gift attributes 130 of the gifting event data record 121 may be replicated into every gift 122 in the system database 120. In further embodiments, data describing the first gifting event 121 may be associated with each gift 122 on the server 300, such as in the system database 120.

In step 606, a gift unique identifier(s) 128 may be generated by the distribution engine 132. In preferred embodiments, once the gifts 122 of the gifting event 121 are created, a gift unique identifier 128 may be generated by the distribution engine 132 for each gift 122 that was assigned or associated to that gifting event 121 in the system database 120. In further embodiments, one or more gift unique identifiers 128 may comprise a Uniform Resource Locator (URL) unique to each gift 122. In still further embodiments, a gift unique identifier(s) 128 may comprise an alphanumeric string, digital code, etc., may be generated by the distribution engine 132 which may be assigned or associated to that gift 122 in the system database 120. Optionally, after step 606, the method 600 may finish 608.

In optional step 607, one or more unique identifiers or any other data describing a gifting event 121 and/or gift 122, such as the gift unique identifier(s) 128 and/or gifting event unique identifier 127 may be provided to one or more gifting users 101A by the communication engine 131. In preferred embodiments, the gift unique identifier(s) 128 and/or gifting event unique identifier 127 may be provided to the client devices 400 of one or more users, such as other gifting users 101A, by the communication engine 131. In still further embodiments, data describing the first gifting event 121 and/or gift 122 may be provided to the client devices 400 of one or more users, such as other gifting users 101A, by the communication engine 131. After step 607, the method 600 may finish 608.

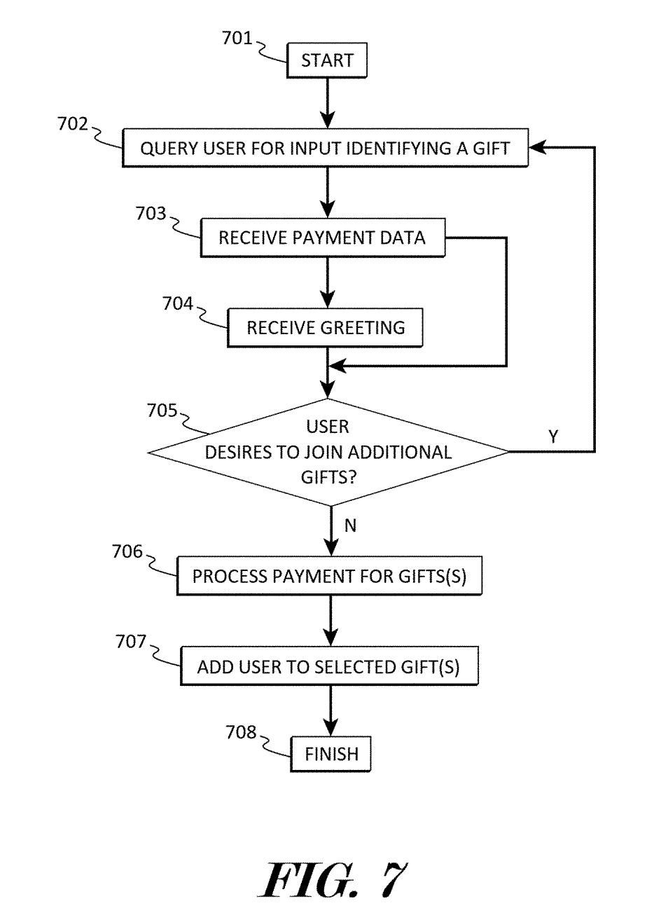

FIG. 7 shows a block diagram of an example of a computer-implemented method for completing a multiple user gifting event transaction (“the method”) 700 according to various embodiments described herein. In some embodiments, the method 700 may be used to enable one or more gifting users 101A to buy a portion of any number of gifts 122 with any number of other gifting users 101A for any number of recipient users 101B. One or more steps of the method 700 may be performed by a communication engine 131, distribution engine 132, and/or transaction engine 133 which may be executed by a computing device processor, such as a processor 302 (FIG. 2) and/or a processor 402 (FIG. 3).

The method 700 may start 701 and a user 101, such as a gifting user 101A, may be queried for input identifying a gift 122, such as a gift unique identifier 128, in step 702. In some embodiments, a user 101 may be queried for input identifying a gift 122 by a communication engine 131 running on their client device 400. Preferably, a gifting user 101A may access a web page or an application screen via the communication engine 131 that shows a desired gifting event 121 including the gifts 122 that are included on that event. The user may select a gift they want to join on their client device 400 and the communication engine 131 may communicate the input identifying a gift 122, such as a gift unique identifier 128, to a transaction engine 133. Optionally, a gift unique identifier 128 may comprise a Uniform Resource Locator (URL) unique to a gift 122. In some embodiments, a gifting user 101A may be queried for input identifying a gift 122 by having the gifting user 101A provide the gifting event unique identifier 127 of the gifting event 121 first and then select a specific gift 122 within the gifting event 121.

In step 703, the system 100 may receive payment data 126 of the gifting user 101A. The payment data 126 of the first user or gifting user 101A may be associated with the gift unique identifier 128 of the gift 122 on a server 300, such as in the system database 120. Preferably, the payment data 126 may include a first gift amount that may describe how much money the gifting user 101A would like to contribute to the gift 122. Optionally, the payment data 126 may include a gift amount that may describe how much money the gifting user 101A would like to contribute to two or more gifts 122 of a gifting event 121. In this manner, a gifting user 101A may specify an amount for a gifting event 121 and then contribute the same amount to one or more gifts within that gifting event 121. In some embodiments, the payment data 126 may be received via the communication engine 131 of the client device of the gifting user 101A. In other embodiments, the payment data 126 may be retrieved from the system database 120 of the server 300. In preferred embodiments, the payment data 126 of the first user or gifting user 101A may also be associated with the gifting event unique identifier 127 of the gifting event 121 that the gift unique identifier 128 of the gift 122 is associated with on a server 300, such as in the system database 120.

In optional step 704, the system 100 may receive a greeting 125 of the gifting user 101A via the communication engine 131. A greeting 125 may comprise a text message, video message, audio message, or other media, which the gifting user 101A may desire to be provided to a recipient user 101B of the gift 122 that they are contributing to. In further embodiments, the system 100 may receive a user credential, such as a login name and password, from the gifting user 101A via their client device 400 which may be associated with the greeting 125 in the system database 120. In still further embodiments, the greeting 125 may be associated with one or more gift unique identifiers 128, such as with each gift unique identifier 128 that the gifting user 101A desires to contribute to. For example, if the gifting user 101A desires to contribute to two gifts 122 of a gifting event 121, the greeting 125 may be associated with a first gift unique identifier 128 of the first gift 122 and with the second gift unique identifier 128 of the second gift 122 on the server 300, such as in the system database 120. In some embodiments, a greeting 125 may be associated with the gift unique identifier 128 of each gift 122 selected by the gifting user 101A on the server 30 after the transaction is completed for the selected gifts 122, such as after the payment is processed successfully.

In decision block 705, the communication engine 131 may determine if the gifting user 101A desires to join or contribute to additional gifts 122. In preferred embodiments, the communication engine 131 may query the gifting user 101A for input indicating that they desire to join or contribute to additional gifts 122 via their client device 400. If the gifting user 101A does not desire to join or contribute to additional gifts 122, the method 700 may proceed to step 706. If the gifting user 101A desires to join or contribute to additional gifts 122, optionally to one or more gifts 122 of a gifting event 121, then the method 700 may proceed to step 702 for each additional gift 122.

In step 706, the transaction engine 133 may process payment for the selected or desired gifts 122. In this manner, the system 100 may enable a gifting user 101A to use the same payment data 126 or payment method for any number of gifts 122, and more preferably for any number of gifts 122 associated with a gifting event 121. In preferred embodiments, the transaction engine 133 may process payment by associating payment data 126 of the gifting user 101A with the gift unique identifier 128 on the server 300, such as in the system database 120, for each selected or desired gift 122. In further preferred embodiments, the transaction engine 133 may process payment by completing a transaction using the payment data 126 of the gifting user 101A on the server, in which the transaction covers the total amount of the contributions for all the selected or desired gifts 122. Preferably, the transaction engine 133 may communicate with a third-party payment server 300 in order to complete the transaction.

In step 707, the gifting user 101A may be added to the selected or desired gifts 122 by the distribution engine 132. In preferred embodiments, may add the gifting user 101A by associating gifting user data 127 of the gifting user 101A with the gift unique identifier 128 on the server 300, such as in the system database 120, for each selected or desired gift 122. In further preferred embodiments, once the gifting user 101A may be added to the selected or desired gifts 122, the communication engine 131 may provide greetings 125 associated with a gift unique identifier 128 of a gift 122 to the recipient user 101B via the client device 400 of the recipient user 101B at a predetermined time of when the gift 122 is to be given to the recipient user 101B. For example, if a gifting user 101A has selected and contributed to two gifts and provided at least one greeting 125 to be associated with the gift unique identifier 128 of each gift 122, the greeting 125 associated with each gift 122 may be provided to the client device 400 of the recipient user 101B of each gift 122. In further preferred embodiments, the greeting 125 associated with gift unique identifier 128 of a gift 122 may not be provided to the client device 400 of the recipient user 101B of the gift 122 until the transaction for the gift 122 has been completed in step 706. After step 707, the method 700 may finish 708.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer-implemented method for creating a multiple user gifting event, the method comprising:
recording, on a server, data describing a gifting event, the data provided via a first client device of a gifting event administration user;
generating, on the server, a gifting event unique identifier for the gifting event
recording, on the server, data describing each recipient user for the gifting event, the data provided via the first client device of the gifting event administration user;
assigning a gift, on the server, to each recipient user; and
generating, on the server, a gift unique identifier for each gift.

2. The method of claim 1, further comprising providing the gift unique identifier to a second user via a second client device.

3. The method of claim 1, further comprising providing data describing the gifting event to a second user via the second client device.

4. The method of claim 1, further comprising receiving a user credential from the first user via the first client device, wherein the data describing each recipient user is associated with the user credential on the server.

5. The method of claim 1, wherein the data describing a recipient user is received from the first client device.

6. The method of claim 1, wherein the data describing a recipient user is retrieved from the server.

7. The method of claim 1, wherein the gift unique identifier is associated with the gifting event unique identifier on the server.

8. The method of claim 1, wherein the gifting event unique identifier comprises a Uniform Resource Locator (URL) unique to the gifting event.

9. A computer-implemented method for completing a multiple user gifting event transaction, the method comprising:
receiving a first gift unique identifier for a first gift from a first user via a first client device;
associating a payment data of the first user with the first gift unique identifier on a server, the payment data including a first gift amount;
receiving a second gift unique identifier from the first user via the first client device;
associating the payment data of the first user with the second gift unique identifier on the server, the payment data including a second gift amount;
completing a transaction using the payment data of the first user on the server, the transaction covering both the first gift amount and second gift amount; and
associating the first user with the first gift unique identifier and the second gift unique identifier on the server.

10. The method of claim 9, further comprising receiving a greeting from the first user via the first client device.

11. The method of claim 10, further comprising receiving a user credential from the first user via the first client device, wherein the greeting is associated with the user credential on the server.

12. The method of claim 10, wherein the greeting is associated with the first gift unique identifier and the second gift unique identifier on the server.

13. The method of claim 10, wherein the greeting is associated with both the first gift unique identifier and the second gift unique identifier on the server after the transaction is completed.

14. The method of claim 10, further comprising receiving a first greeting and a second greeting from the first user via the first client device, wherein the first greeting is associated with the first gift unique identifier on the server, and wherein the second greeting is associated with the second gift unique identifier on the server.

15. The method of claim 14, further comprising providing the first greeting to a client device of a first recipient user, and further comprising providing the second greeting to a client device of a second recipient user.

16. The method of claim 14, wherein both the first greeting is provided to the client device of the first recipient user and the second greeting is provided to the client device of the second recipient user after the transaction is completed.

17. The method of claim 9, wherein the payment data of the first user is received from the first client device.

18. The method of claim 9, wherein the payment data of the first user is retrieved from the server.

19. The method of claim 18, further comprising receiving a user credential from the first user via the first client device, wherein the payment data of the first user is associated with the user credential on the server.

20. The method of claim 9, wherein the first gift unique identifier comprises a Uniform Resource Locator (URL) unique to the first gift.
